(19) United States
(12) Patent Application Publication
(10) Pub. No.: US 2025/0124050 A1
(43) Pub. Date: Apr. 17, 2025

(54) DATA STORAGE METHOD AND APPARATUS, AND ELECTRONIC DEVICE

(71) Applicant: BEIJING OCEANBASE TECHNOLOGY CO., LTD., Beijing, (CN)

(72) Inventor: Qi YANG, Beijing, (CN)

(21) Appl. No.: 18/972,386

(22) Filed: Dec. 6, 2024

Related U.S. Application Data
(63) Continuation of application No. PCT/CN2023/141526, filed on Dec. 26, 2023.

(30) Foreign Application Priority Data
Feb. 21, 2023 (CN) 202310147884.2

(51) Int. Cl. G06F 16/27; G06F 16/22

(52) U.S. Cl. CPC G06F 16/27; G06F 16/2282

(57) ABSTRACT

The present application provides a data storage method and apparatus, and an electronic device, and pertains to the field of data storage technologies. The data storage method in implementations of the present application includes: in response to that metadata that corresponds to a data table in the database and that is independently maintained at a server side changes, setting the second data table to be in an unmodifiable state, and writing incremental data in the second data table to a first data table in a persistent storage space at the server side; and creating a new second data table corresponding to changed metadata, and recording newly obtained incremental data in the second data table. In this way, when a storage space of the metadata is greatly reduced, changed metadata can become valid in real time, without affecting a write operation of data.

### TECHNICAL FIELD

The present application pertains to the field of data storage technologies, and specifically, relates to a data storage method and apparatus, and an electronic device.

### BACKGROUND

User data stored in a database can include data and metadata, and the metadata is referred to as data of the data and is used to explain the data. If a data type of the user data is structured data, for example, data can be recorded in a form of a table structure, the metadata can include metadata used to explain basic information of the table structure. After a table structure is defined, the table structure can be adjusted based on a predefined modification statement, leading to a change in corresponding metadata. After the metadata changes, metadata of different versions is used with data of different versions: Metadata of a new version cannot accurately explain data of an old version; and metadata of the old version cannot explain data of the new version either.

In view of the change in the metadata, in a related technology, the metadata can be changed based on an original table structure, but writing of new data is temporarily stopped, and can be continued after the change in the metadata is completed, thereby affecting a write operation on the database, and further affecting a service.

### SUMMARY

In view of this, the present application provides a data storage method and apparatus, and an electronic device, to resolve a problem that when metadata changes, writing of new data is temporarily stopped, and a write operation on a database is affected.

For example, the present application is implemented by using the following technical solutions.

According to a first aspect, a data storage method is provided, applied to a server side. A database is deployed at the server side, the database includes a plurality of first data tables stored in a persistent storage space at the server side and a second data table stored in a cache space at the server side, the second data table is used to store incremental data to be written to the first data table, and the method includes: in response to that metadata that corresponds to a data table in the database that is independently maintained at the server side changes, setting the second data table to be in an unmodifiable state, and writing the incremental data in the second data table to the first data table in the persistent storage space at the server side; and creating a new second data table corresponding to changed metadata, and recording newly obtained incremental data in the second data table.

For example, the server side includes a metadata manager, the metadata manager is configured to maintain the metadata corresponding to the data table in the database and an identifier of the metadata, the first data table stores an identifier of metadata corresponding to the first data table, and the second data table stores an identifier of metadata corresponding to the second data table.

For example, the metadata manager maintains metadata in a form of a key-value pair, a key in the key-value pair is an identifier of the metadata, and a value in the key-value pair is the metadata.

For example, the database is a database that uses an LSM-tree storage engine.

For example, before the in response to that the metadata that corresponds to the data table in the database and that is independently maintained at the server side changes, setting the second data table to be in the unmodifiable state, and writing the incremental data in the second data table to the first data table in the persistent storage space at the server side, the method further includes: determining whether any one of at least one predetermined change condition is satisfied; and if yes, determining that the metadata corresponding to the data table in the database changes. The change condition includes at least one of the following: the metadata that corresponds to the data table in the database and that is maintained by the metadata manager changes; and metadata corresponding to the obtained new incremental data is different from the metadata corresponding to the second data table.

For example, the metadata is used to explain a data entry written to the data table, and the method further includes: in response to that a data query request is obtained, querying a target data entry from the plurality of first data tables, and querying metadata corresponding to the target data entry from the metadata manager based on an identifier of metadata corresponding to a first data table in which the target data entry is located, to explain the target data entry.

For example, the method further includes: combining the plurality of first data tables into a target first data table in response to a data table combination request for the plurality of first data tables.

For example, the combining the plurality of first data tables into the target first data table includes: obtaining latest metadata from the metadata manager based on an identifier of metadata stored in each of the plurality of first data tables, and using the latest metadata as target metadata; and storing each data entry in the plurality of first data tables at a corresponding location in the target first data table based on the target metadata.

According to a second aspect, a data storage apparatus is provided. The apparatus includes: a first execution module, configured to: in response to that metadata that corresponds to a data table in a database and that is independently maintained at a server side changes, set a second data table to be in an unmodifiable state, and write incremental data in the second data table to a first data table in a persistent storage space at the server side; and a second execution module, configured to: create a new second data table corresponding to changed metadata, and record newly obtained incremental data in the second data table.

According to a third aspect, a computer-readable storage medium is provided. The computer-readable storage medium stores a computer program, and when the program is executed by a processor, steps of the method in the first aspect are implemented.

According to a fourth aspect, an electronic device is provided, including a storage device, a processor, and a computer program that is stored in the storage device and that is capable of running on the processor. When the processor executes the program, steps of the method in the first aspect are implemented.

The server side independently maintains the metadata corresponding to the data table in the database without storing the metadata in the data table. When the metadata changes, the metadata in the data table does not need to be updated. The new second data table corresponding to the changed metadata is created, to store the incremental data obtained after the metadata changes. In this way, when a storage space of the metadata is greatly reduced, changed metadata can become valid in real time, without affecting a write operation of data.

### BRIEF DESCRIPTION OF DRAWINGS

FIG. 1 is a schematic flowchart illustrating a data storage method according to an example implementation of the present application;

FIG. 2 is a schematic diagram illustrating data storage at a server side used to implement a data storage method according to an example implementation of the present application;

FIG. 3 is a schematic diagram illustrating data storage at a server side used to implement a data storage method according to an example implementation of the present application;

FIG. 4 is a schematic flowchart illustrating a first data table combination operation according to an example implementation of the present application;

FIG. 5 is a schematic structural diagram illustrating a data storage apparatus according to an example implementation of the present application; and

FIG. 6 is a schematic structural diagram illustrating an electronic device according to an example implementation of the present application.

### DESCRIPTION OF IMPLEMENTATIONS

Example implementations are described in detail herein, and examples of the example implementations are presented in the accompanying drawings. When the following description relates to the accompanying drawings, unless specified otherwise, same numbers in different accompanying drawings represent same or similar elements. The implementations described in the following example implementations do not represent all implementations consistent with the present application. On the contrary, the implementations are merely examples of apparatuses and methods consistent with some aspects of the present application including those described in detail in the appended claims.

The terms used in the present application are merely for illustrating specific implementations, and are not intended to limit the present application. The terms “a”, “said”, and “the” of singular forms used in the present application and the appended claims are also intended to include plural forms, unless otherwise specified in the context clearly. It should be further understood that the term “and/or” used in the present specification indicates and includes any or all possible combinations of one or more associated listed items.

It should be understood that although terms “first”, “second”, “third”, etc. may be used in the present application to describe various types of information, the information is not limited to the terms. These terms are merely used to distinguish information of a same type from each other. For example, without departing from the scope of the present application, first information can also be referred to as second information, and similarly, the second information can be referred to as the first information. Depending on the context, for example, the word “if” used here can be explained as “while”, “when”, or “in response to determining”.

User data stored in a database can include data and metadata, and the metadata is referred to as data of the data and is used to explain the data. For user data of a structured data type, for example, user data of data recorded in a form of a table structure, the metadata can include metadata used to explain basic information of the table structure, or can be referred to as table metadata. The table metadata can include metadata used to explain the following two types of information: basic information of a table: a compression algorithm, an encryption algorithm, a size of a data block used for storage, the number of attributes, etc.; and basic information of an attribute, also referred to as basic information of a column: a type of each column, a subscript of the column, a default value of the column, etc.

It should be noted that a change in the metadata described in this specification is mainly a change in metadata related to the attribute.

Data filled in the table structure defined by the metadata is data in the user data. The data cannot exist independently, and is explained based on the corresponding metadata.

After a table structure is defined, the table structure can be adjusted based on a predefined modification statement, which is referred to as performing one metadata change on the table structure. For example, attribute addition, attribute deletion, attribute type modification, etc. is referred to as a change in the basic information of the attribute. The change in the metadata leads to generation of a new table structure. After the metadata changes, metadata of different versions is used together with data of different versions, leading to the following problems: Metadata of a new version cannot accurately explain data of an old version. For example, after an attribute deletion operation and an attribute addition operation are performed on the table structure, if corresponding data of data of the old version is not rewritten in a timely manner during attribute deletion and attribute addition, and metadata of a new version is used to explain the data of the old version, an attribute may be explained incorrectly. The metadata of the old version cannot explain the data of the new version either. For example, an attribute addition operation is performed on the table structure. Because basic information of an added attribute does not exist in metadata of an old version, data of a new version cannot be explained.

For the change in the metadata, the following two manners are mainly used in a related technology: 1. In a copy (COPY) manner, the metadata of the new version is used to create a new table structure that is temporarily invisible to a user. Data in an original table structure is queried and rewritten to the new table structure. After data writing is completed, the original table structure is replaced with the new table structure, the original table structure is deleted, and the metadata of the old version is replaced with the metadata of the new version. A disadvantage of this solution is as follows: For a table with a relatively large amount of data, it takes a large amount of time to perform data querying and writing. Before data writing is completed, data exists in the original table structure and the new table structure, resulting in a plurality of pieces of redundant data and increasing a storage space requirement. 2. In a replacement (INPLACE) manner, the change in the metadata is performed based on the original table structure. Because corresponding metadata is also stored in a data table used to store data, writing of new data is temporarily stopped when the change in the metadata is performed, and can be continued after the change in the metadata is completed, affecting a write operation on a database, and further affecting a service.

In view of this, this specification provides a data storage method. A database is deployed at a server side. The database includes a plurality of first data tables stored in a persistent storage space at the server side and a second data table stored in a cache space at the server side, the second data table is used to store incremental data to be written to the first data table, and the server side independently maintains metadata corresponding to a data table in the database.

During implementation, in response to that the metadata that corresponds to the data table in the database and that is independently maintained at the server side changes, the second data table is set to be in an unmodifiable state, and incremental data in the second data table is written to the first data table in the persistent storage space at the server side. A new second data table corresponding to changed metadata is created, and newly obtained incremental data is recorded in the second data table.

In some technical solutions herein, the server side independently maintains the metadata corresponding to the data table in the database without storing the metadata in the data table. When the metadata changes, the metadata in the data table does not need to be updated. The new second data table corresponding to the changed metadata is created, to store the incremental data obtained after the metadata changes. In this way, when a storage space of the metadata is greatly reduced, changed metadata can become valid in real time, without affecting a write operation of data.

To enable a person skilled in the art to better understand the technical solutions in the present application, the following clearly and completely describes technical solutions in implementations of the present application with reference to the accompanying drawings in implementations of the present application.

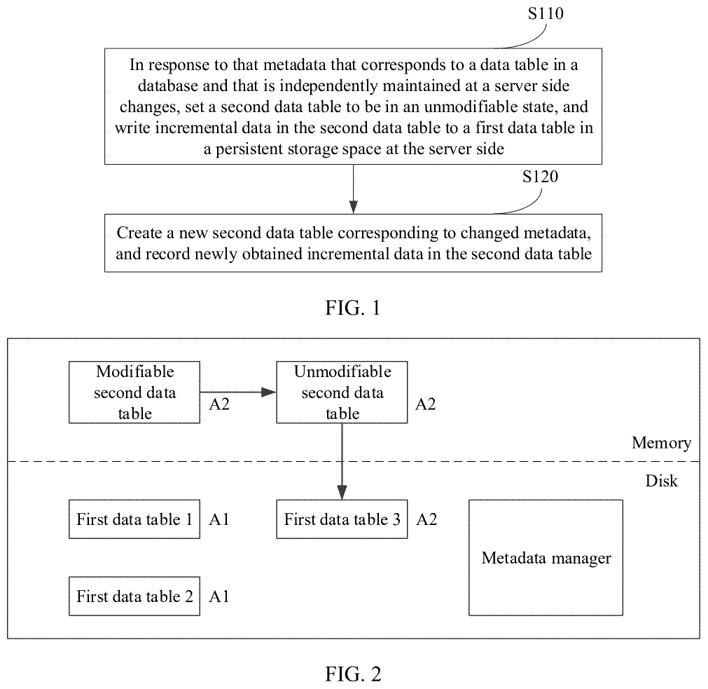

FIG. 1 shows a data storage method according to an implementation of the present application. The method is applied to a server side, a database is deployed at the server side, the database includes a plurality of first data tables stored in a persistent storage space at the server side and a second data table stored in a cache space at the server side, and the second data table is used to store incremental data to be written to the first data table.

The server side can be a server or a server cluster configured to provide a service for a user. This is not specifically limited herein.

A plurality of databases can be deployed at the server side. For example, the plurality of databases can be a key-value storage database, a column storage database, a document database, or a graph database. In an implementation, the database deployed at the server side in this specification is a database that uses a log structured merge-tree (LSM-Tree) storage engine.

As shown in FIG. 2, data stored in the database includes two parts: the plurality of first data tables stored in the persistent storage space at the server side and the second data table stored in the cache space at the server side.

The persistent storage space at the server side can be, for example, a disk or a hard disk. The first data table in the persistent storage space at the server side can be an internally ordered file, or can be referred to as a sorted string table (SSTable), and data stored in the first data table can be referred to as baseline data. The baseline data can include a plurality of data entries, and the plurality of data entries can be explained by metadata of a version corresponding to the first data table.

The persistent storage space at the server side can store the plurality of first data tables, each first data table corresponds to metadata of one version, and different first data tables can correspond to metadata of different versions, or can correspond to metadata of the same version. As shown in FIG. 2, the persistent storage space includes a first data table 1, a first data table 2, and a first data table 3; the first data table 1 and the first data table 2 correspond to metadata of the same version A1, and a version of metadata corresponding to the first data table 3 is A2.

The cache space at the server side can be, for example, a memory at the server side. The cache space at the server side stores one second data table, the second data table can also be referred to as a memory table (Mem Table), and data stored in the second data table can be referred to as incremental data. Each piece of incremental data can be a newly added data entry, and the newly added data entry can be explained by metadata of a version corresponding to the second data table. As shown in FIG. 2, a version of metadata corresponding to the second data table is A2.

The server side further independently maintains the metadata corresponding to the data table in the database, and can, for example, include version management on the metadata. The metadata is used to explain a data entry written to the data table, and metadata of different versions is used to explain data entries written to corresponding data tables. The server side can maintain the metadata in various manners. The manners are not specifically limited in this specification. For example, a metadata manager shown in FIG. 2 is used as an example for description. The server side includes a metadata manager, and the metadata manager is configured to maintain the metadata corresponding to the data table in the database. After the server side obtains a modification statement of the user for the metadata, the metadata manager modifies the metadata, and performs version management.

At the server side, steps of the data storage method are as follows:

S110: In response to that metadata that corresponds to a data table in the database and that is independently maintained at the server side changes, set the second data table to be in an unmodifiable state, and write the incremental data in the second data table to the first data table in the persistent storage space at the server side.

When obtaining the incremental data, the server side can write the incremental data to a second data table in a cache space. In this case, the second data table is in a modifiable state, and can be referred to as a modifiable second data table.

In a process of obtaining the incremental data, the server side can monitor whether the metadata corresponding to the data table in the database changes.

If the server side determines that the metadata corresponding to the data table in the database does not change, when the incremental data in the second data table currently reaches a predetermined amount of data threshold, the second data table can be set to the unmodifiable state, and becomes an unmodifiable second data table shown in FIG. 2, and then incremental data in the unmodifiable second data table is written to the persistent storage space at the server side, and becomes baseline data.

If the server side determines that the metadata corresponding to the data table in the database changes, regardless of whether the incremental data in the second data table currently reaches the predetermined amount of data threshold, the second data table is set to the unmodifiable state, and then the incremental data in the unmodifiable second data table is written to the persistent storage space at the server side and becomes baseline data.

The incremental data in the second data table can be written to the persistent storage space at the server side in various manners. For example, the entire second data table can be imported from the cache space to the persistent storage space to become a new first data table, and the new first data table and the second data table correspond to metadata of the same version. The incremental data in the second data table can be further written to a first data table that has metadata of the same version as the second data table in the plurality of first data tables in the persistent storage space. In an implementation, whether a first data table that has metadata of the same version as the second data table exists in the persistent storage space can be first queried. If no first data table that has metadata of the same version exists, a new first data table that has metadata of the same version as the second data table is created in the persistent storage space, and then the incremental data in the second data table is written to the new first data table; or if a first data table that has metadata of the same version exists, whether baseline data in the first data table that has metadata of the same version reaches a predetermined threshold can be queried. If the threshold is not reached, the incremental data in the second data table is incorporated into the first data table that has metadata of the same version; or if the threshold is reached, a new first data table that has metadata of the same version as the second data table is created in the persistent storage space, and then the incremental data in the second data table is written to the new first data table.

The server side can determine, in various manners, whether the metadata corresponding to the data table in the database changes. A plurality of change conditions can be predetermined. Whether the metadata corresponding to the data table in the database change is determined by determining whether any one of the change conditions is satisfied. If any one of the change conditions is satisfied, it is determined that the metadata corresponding to the data table in the database changes. The change condition can be set based on an actual requirement, and can include at least one of the following: The metadata that corresponds to the data table in the database and that is maintained by the metadata manager changes. For example, this can be that the server side obtains a modification statement of the user for the metadata; or obtains a modification statement for an attribute of the metadata; or can be a message that indicates that the metadata change and that is obtained after the metadata manager completes modification of the metadata. The message indicating that the metadata change can include an identifier of changed metadata, etc. Metadata corresponding to obtained new incremental data is different from metadata corresponding to the second data table. For example, a version of the metadata corresponding to the obtained new incremental data is different from a version of the metadata corresponding to the second data table; or an identifier of the metadata corresponding to the obtained new incremental data is different from an identifier of the metadata stored in the second data table; or the metadata corresponding to the obtained new incremental data is different from the metadata corresponding to the second data table in basic information of any attribute; or the number of attributes corresponding to a data entry included in the obtained new incremental data is different from the number of attributes corresponding to a data entry in stored incremental data in the second data table.

It should be noted that, that the server side determines whether the metadata corresponding to the data table in the database change can be for any change in the metadata; or can be for a change in metadata related to an attribute in the metadata; or can be for a change in metadata related to a plurality of pieces of information about an attribute in the metadata. The plurality of pieces of information about the attribute can be set based on an actual requirement, for example, is the number of attributes or an attribute sort. If only the metadata related to the attribute in the metadata changes, after determining that the metadata corresponding to the data table in the database changes, the server side further determines whether a current change is a change in the metadata related to the attribute. If yes, the second data table is set to the unmodifiable state, and the incremental data in the second data table is written to the first data table in the persistent storage space at the server side; or if no, an operation is performed still based on a case in which the metadata does not change.

S120: Create a new second data table corresponding to the changed metadata, and record the newly obtained incremental data in the second data table.

When the server side sets the second data table to an unmodifiable state, and writes the incremental data in the second data table to the first data table in the persistent storage space at the server side, the server side recreates a new second data table in the cache space. The new second data table corresponds to the changed metadata. That is, the new second data table corresponds to a version corresponding to the changed metadata. For example, after the incremental data in the second data table shown in FIG. 2 is written to the first data table in the persistent storage space at the server side, the version of the metadata corresponding to the new data table created in the cache space at the server side can be A3 or A1.

To facilitate management of the metadata, the metadata manager configures corresponding identifiers for metadata of different versions, and the metadata manager is configured to maintain the metadata corresponding to the data table in the database and an identifier corresponding to the metadata. An identifier configured by the metadata manager for each piece of metadata can be a unique identifier. For example, the identifier of each piece of metadata can be obtained based on a version number corresponding to each piece of metadata. For example, the identifier can be formed by combining a table unique label and a version number of the metadata.

When the server side obtains the modification statement of the user for the metadata, the metadata manager can modify the metadata, and determine whether a new identifier is to be configured.

It should be noted that the metadata manager can further provide a concurrent lock to prevent a concurrent modification problem caused when a plurality of threads perform operations on the same key-value pair. In addition, a frequently accessed key-value pair can be further cached in the cache space, to reduce disk reading and writing caused by access to the metadata.

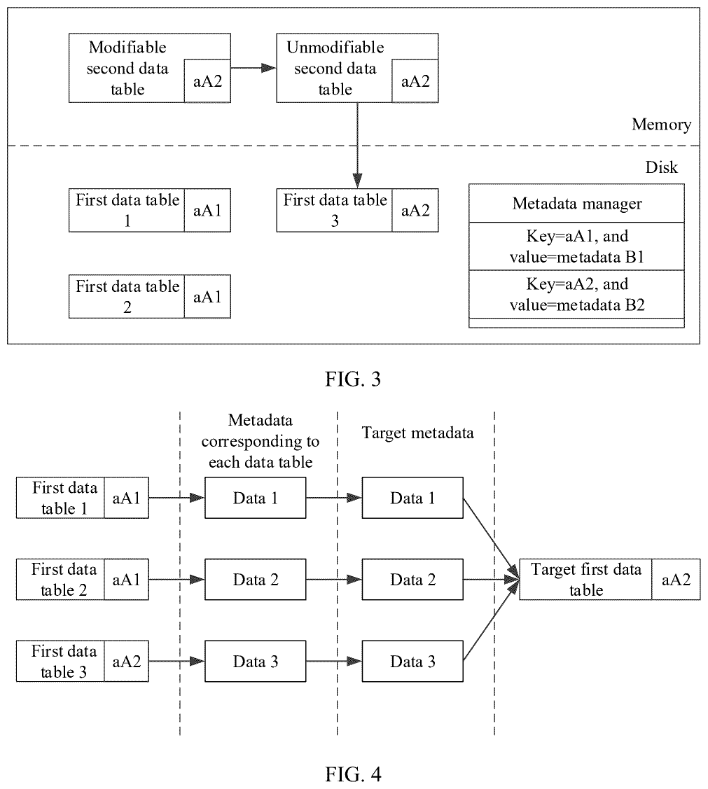

Correspondingly, to indicate a correspondence between each data table and metadata, the first data table can store an identifier of metadata corresponding to the first data table, and the second data table can store an identifier of metadata corresponding to the second data table. As shown in FIG. 3, an identifier aA1 is stored in a first data table 1 and a second data table 2, and is used to indicate metadata corresponding to a version A1 in the first data table 1 and the first data table 2. An identifier aA2 is stored in a first data table 3, and is used to indicate metadata corresponding to a version A2 in the first data table 3. The identifier aA2 is stored in the second data table, and is used to indicate metadata corresponding to the version A2 in the second data table.

The server side can query metadata corresponding to each data table from the metadata manager based on an identifier that is of the metadata and that is stored in each data table.

The metadata manager can maintain, in various manners, the metadata corresponding to the data table in the database and the identifier of the metadata. The manners are not specifically limited in this specification. For example, the metadata can be maintained in a form of a key-value pair. In other words, the metadata is stored by using a key-value storage engine. The key-value pair can be represented as “identifier of metadata, metadata”. The key in the key-value pair is the identifier of the metadata, and the value in the key-value pair is the metadata. A correspondence table between each metadata and an identifier can be further maintained in the metadata manager. As shown in FIG. 3, the key-value pair maintained by the metadata manager can include “key=aA1, and value=metadata B1” and “key=aA2, and value=metadata B2”. Therefore, the server side can query the metadata B1 corresponding to aA1, namely, metadata of the version A1 from the metadata manager based on the identifier aA1 stored in the data table; and query the metadata B2 corresponding to aA2, namely, metadata of the version A2 from the metadata manager based on the identifier aA2 stored in the data table.

In this implementation of the present application, the server side independently maintains the metadata corresponding to the data table in the database without storing the metadata in the data table. When the metadata changes, a write operation does not need to be interrupted to update the metadata in the data table. The new second data table corresponding to the changed metadata is created, to store the incremental data obtained after the metadata changes. In this way, when a storage space of the metadata is greatly reduced, changed metadata can become valid in real time, without affecting a write operation of data.

Based on some implementations herein, when data is queried from the database, a data query request can be sent to the server side. The method further includes: In response to the data query request, the server side can query, in the plurality of first data tables, whether a target data entry corresponding to the data query request exists; and if a target data entry corresponding to the data query request exists, read, from a first data table in which the target data entry is located, the target data entry and an identifier of metadata corresponding to the first data table; and query metadata corresponding to the target data entry from the metadata manager based on the identifier of the metadata corresponding to the first data table in which the target data entry is located, to explain the target data entry. A query result obtained based on the target data entry and the corresponding metadata is returned to the user, for example, can be a table structure filled with the target data entry.

It should be noted that, in response to that the data query request is obtained, before querying, from the plurality of first data tables, whether the target data entry corresponding to the data query request exists, the server side can further first query, in the second data table, whether the target data entry corresponding to the data query request exists; and if the target data entry corresponding to the data query request does not exist, query, in the plurality of first data tables, whether the target data entry corresponding to the data query request exists; or if the target data entry corresponding to the data query request exists, read the target data entry and the identifier of the metadata corresponding to the second data table from the second data table, and query the metadata corresponding to the target data entry from the metadata manager based on the identifier of the metadata corresponding to the second data table, to explain the target data entry.

The metadata manager can be used to greatly reduce the storage space of the metadata, and accurately query metadata of all versions corresponding to the data entry, so that all data entries can be accurately explained.

Based on some implementations herein, a combination operation can be periodically performed on the plurality of first data tables in the persistent storage space, to reduce the number of increasing first data tables in the persistent storage space and a storage space required for an amount of data stored in the first data tables. The server side combines the plurality of first data tables into a target first data table in response to a data table combination request for the plurality of first data tables. A process of the combination operation can be as follows:

The server side determines, based on the data table combination request, a plurality of first data tables on which the combination operation is to be performed. The first data tables on which the combination operation is to be performed can be some specified first data tables in all the first data tables in the persistent storage space, or can be a plurality of newly generated first data tables in the persistent storage space.

After determining the plurality of first data tables on which the combination operation is to be performed, the server side traverses all the first data tables on which the combination operation is to be performed; reads an identifier of metadata stored in each first data table; and obtains latest metadata from the metadata manager based on the identifier of the metadata stored in each first data table, and uses the latest metadata as target metadata. The latest metadata can be latest metadata in metadata corresponding to identifiers of metadata stored in all the first data tables, or can be latest metadata in metadata of all versions in the metadata manager. For example, as shown in FIG. 4, if the first data table on which the combination operation is to be performed include the first data table 1, the first data table 2, and the first data table 3, and identifiers of metadata stored in the first data table 1 and the second data table 2 are aA1, and an identifier of metadata stored in the first data table 3 is aA2, the metadata that corresponds to aA1 and that is queried from the metadata manager is the metadata of the version A1, and the metadata corresponding to aA2 is the metadata of the version A2. If the latest metadata in the metadata manager is metadata of the version A2 currently, the metadata of the version A2 is used as target metadata, and an identifier of metadata stored in the generated target first data table is aA2, as shown in FIG. 4. If the latest metadata in the metadata manager is the metadata of the version A3 currently, the metadata of the version A3 is used as the target metadata, and an identifier of metadata stored in the generated target first data table is aA3.

After determining the target metadata, the server side can store each data entry in the plurality of first data tables at a corresponding location in the target first data table based on the target metadata. As shown in FIG. 4, the server side can first read, based on metadata corresponding to each first data table, data stored in each first data table. The data stored in each first data table includes a plurality of data entries. Then, data in a data entry read from each first data table is projected based on the target metadata, and is adjusted to data that conforms to the target metadata, that is, is adjusted to data that can be explained by the target metadata. After data adjustment is completed, the adjusted data is written to the generated target first data table based on a predetermined sorting rule, and an identifier corresponding to the target metadata is stored in the target first data table.

The data read from each first data table is adjusted based on the target metadata. A specific adjustment manner can include: If any attribute in the metadata corresponding to the first data table does not exist in the target metadata, data corresponding to the any attribute is discarded from each data entry of data read from the first data table; or if no attribute in the target metadata exists in the metadata corresponding to the first data table, a location of data corresponding to the any attribute is added to each data entry read from the first data table, and a default value corresponding to the any attribute is filled; or if the metadata corresponding to the first data table is different from the target metadata in basic information of any attribute, data corresponding to the any attribute in each data entry of the data read from the first data table is adjusted based on the basic information of the any attribute in the target metadata.

It should be noted that, as the metadata continuously changes, metadata stored in the metadata manager increase. Therefore, the metadata manager can further provide a periodic metadata recovery mechanism, that is, perform periodic cleaning. For example, whether to perform cleaning can be determined based on a correspondence between each metadata and a first data table and a lifecycle of the metadata. Identifiers of metadata stored in all the first data tables in the persistent storage space can be traversed periodically, and metadata corresponding to identifiers of metadata that does not exist in a traversal process in the metadata manager can be cleaned. The metadata that is to be cleaned can be further required to satisfy a condition that a life time exceeds a predetermined life cycle.

Some storage spaces can be freed by performing a combination operation on a plurality of first data tables in the persistent storage space, to reduce storage pressure on the persistent storage space, and data in the plurality of first data tables can be adjusted, by performing the combination operation, to data that conforms to the latest metadata, to implement data integration.

It should be noted that a single table structure can be divided into a plurality of partitions, and different partitions can respectively correspond to respective first data tables, second data tables, and metadata. According to a manner of obtaining partitions through division, different partitions can correspond to different metadata, or can correspond to the same metadata. If different partitions correspond to the same metadata, the same key-value pair can be used in the metadata manager, to greatly reduce metadata repetition and a storage amount.

Corresponding to some implementations herein of the data storage method, the present application further provides an implementation of a data storage apparatus.

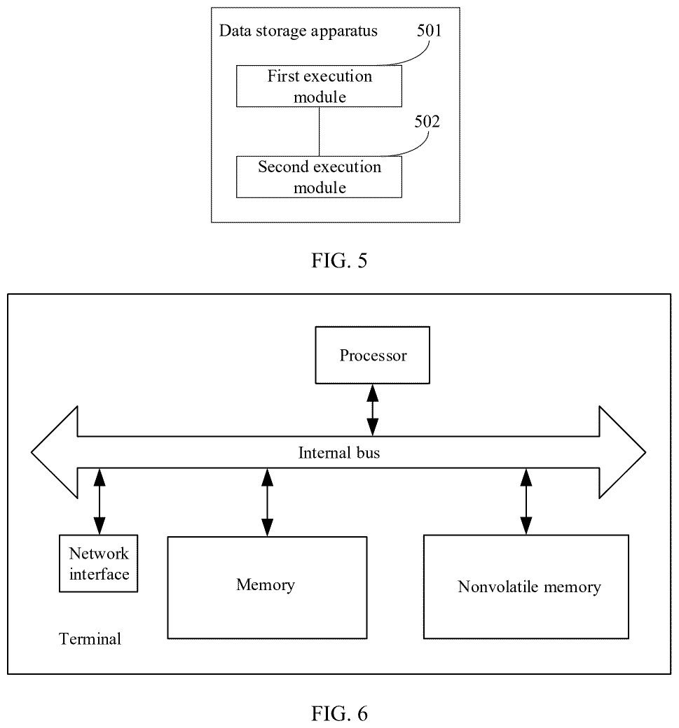

As shown in FIG. 5, the data storage apparatus includes a first execution module 501 and a second execution module 502.

The first execution module 501 is configured to: in response to that metadata that corresponds to a data table in a database and that is independently maintained at a server side changes, set a second data table to be in an unmodifiable state, and write incremental data in the second data table to a first data table in a persistent storage space at the server side. The second execution module 502 is configured to: create a new second data table corresponding to changed metadata, and record newly obtained incremental data in the second data table.

For example, the server side includes a metadata manager, the metadata manager is configured to maintain the metadata corresponding to the data table in the database and an identifier of the metadata, the first data table stores an identifier of metadata corresponding to the first data table, and the second data table stores an identifier of metadata corresponding to the second data table.

For example, the metadata manager maintains metadata in a form of a key-value pair, a key in the key-value pair is an identifier of the metadata, and a value in the key-value pair is the metadata.

For example, the database is a database that uses an LSM-tree storage engine.

For example, the first execution module 501 is further configured to: determine whether any one of at least one predetermined change condition is satisfied; and if yes, determine that the metadata corresponding to the data table in the database changes. The change condition includes at least one of the following: the metadata that corresponds to the data table in the database and that is maintained by the metadata manager changes; and metadata corresponding to the obtained new incremental data is different from the metadata corresponding to the second data table.

In this implementation of the present application, the server side independently maintains the metadata corresponding to the data table in the database without storing the metadata in the data table. When the metadata changes, a write operation does not need to be interrupted to update the metadata in the data table. The new second data table corresponding to the changed metadata is created, to store the incremental data obtained after the metadata changes. In this way, when a storage space of the metadata is greatly reduced, changed metadata can become valid in real time, without affecting a write operation of data.

For example, the metadata is used to explain a data entry written to the data table, and the first execution module 501 is further configured to: in response to that a data query request is obtained, query a target data entry from the plurality of first data tables, and query metadata corresponding to the target data entry from the metadata manager based on an identifier of metadata corresponding to a first data table in which the target data entry is located, to explain the target data entry.

The metadata manager can be used to greatly reduce the storage space of the metadata, and accurately query metadata of all versions corresponding to the data entry, so that all data entries can be accurately explained.

For example, the first execution module 501 is further configured to combine the plurality of first data tables into a target first data table in response to a data table combination request for the plurality of first data tables.

For example, the first execution module 501 is further configured to: obtain latest metadata from the metadata manager based on an identifier of metadata stored in each of the plurality of first data tables, and use the latest metadata as target metadata; and store each data entry in the plurality of first data tables at a corresponding location in the target first data table based on the target metadata.

Some storage spaces can be freed by performing a combination operation on a plurality of first data tables in the persistent storage space, to reduce storage pressure on the persistent storage space, and data in the plurality of first data tables can be adjusted, by performing the combination operation, to data that conforms to the latest metadata, to implement data integration.

The implementation of the data storage apparatus in the present application can be applied to an electronic device. The apparatus implementation can be implemented by using software, or can be implemented by using hardware or a combination of software and hardware. That the apparatus implementation is implemented by using software is taken as an example. A logical apparatus is implemented by reading, by using a processor of an electronic device in which the apparatus is located, corresponding computer program instructions in a nonvolatile memory into a memory for running. In terms of a hardware level, FIG. 6 is a diagram of a hardware structure of an electronic device in which a data storage apparatus is located. In addition to a processor, a memory, a network interface, and a nonvolatile memory shown in FIG. 6, the electronic device in which the apparatus is located in this implementation usually can further include other hardware based on an actual function of the electronic device. Details are omitted herein for simplicity.

For an implementation process of functions and roles of each unit in the apparatus, references can be made to an implementation process of corresponding steps in the method herein. Details are omitted herein.

Because an apparatus implementation basically corresponds to a method implementation, for related parts, references can be made to related descriptions in the method implementation. The apparatus implementation described herein is merely an example. The units described as separate parts can or cannot be physically separate, and parts displayed as units can or cannot be physical units, that is, can be located in one place, or can be distributed on a plurality of network units. Some or all of the modules can be selected based on an actual requirement, to achieve objectives of the solutions of the present application. A person of ordinary skill in the art can understand and implement the solutions of the present application without creative efforts.

An implementation of the present application further provides a computer-readable storage medium. The computer-readable storage medium stores a computer program. When the program is executed by a processor, steps of the data storage method can be implemented, and the same technical effect can be achieved. To avoid repetition, details are omitted herein for simplicity.

It should be noted that, user information (including but not limited to a device information of a user, personal information of a user, etc.) and data (including but not limited to data used for analysis, stored data, displayed data, etc.) used in the present application are information and data that is authorized by the user or fully authorized by each party, related data is collected, used, and processed by abiding by related laws and regulations and standards of a related country and region, and a corresponding operation entry is provided, so that the user chooses to perform authorization or rejection.

Implementations of the subject and function operations described in this specification can be implemented in the following: a digital electronic circuit, tangible computer software or firmware, computer hardware including a structure disclosed in this specification and structural equivalents thereof, or a combination of one or more thereof. Implementations of the subject matter described in this specification can be implemented as one or more computer programs, that is, one or more modules in computer program instructions encoded on a tangible non-temporary program carrier to be executed by a data processing apparatus or to control an operation of a data processing apparatus. Alternatively or additionally, the program instructions can be encoded on a manually generated propagation signal, for example, an electrical signal, an optical signal, or an electromagnetic signal generated by a machine. The signal is generated to encode and transmit information to a proper receiver apparatus for execution by the data processing apparatus. The computer storage medium can be a machine-readable storage device, a machine-readable storage substrate, a random or serial access memory device, or a combination of one or more thereof.

Processing and logic processes described in this specification can be executed by one or more programmable computers that execute one or more computer programs, to perform corresponding functions by performing an operation based on input data and generating an output. The processing and logic processes can alternatively be performed by a dedicated logic circuit, for example, a field programmable gate array (FPGA) or an application-specific integrated circuit (ASIC), and the apparatus can alternatively be implemented as a dedicated logic circuit.

Computers suitable for executing the computer programs include, for example, general-purpose and/or dedicated microprocessors, or any other type of central processing unit. Usually, the central processing unit receives instructions and data from the read-only memory and/or the random access memory. A basic component of the computer includes a central processing unit for implementing or executing instructions and one or more memory devices configured to store the instructions and data. Generally, the computer further includes one or more large-capacity storage devices for storing data such as a magnetic disk, a magneto-optical disk, or an optical disk, or the computer is operably coupled to the large-capacity storage device to receive data from or transmit data to the large-capacity storage device, or both. However, the computer is not necessarily such a device. In addition, the computer can be embedded into another device, for example, a mobile phone, a personal digital assistant (PDA), a mobile audio or video player, a game console, a global positioning system (GPS) receiver, or a portable storage device such as a universal serial bus (USB) flash drive. Merely a plurality of examples are given.

A computer-readable medium adapted to store computer program instructions and data includes all forms of nonvolatile memories, media, and memory devices such as a semiconductor memory device (for example, an EPROM, an EEPROM, and a flash memory device), a magnetic disk (for example, an internal hard disk or a removable disk), a magneto-optical disk, a CD-ROM disk, and a DVD-ROM disk. The processor and a storage device can be supplemented by or incorporated into a dedicated logic circuit.

Although this specification includes many specific implementation details, which should not be construed as limiting the scope of any invention or the claimed scope, but are mainly intended to describe the features of specific implementations of a particular invention. Some features described in a plurality of implementations of this specification can also be implemented in combination in a single implementation. In addition, various features described in a single implementation can also be implemented separately in a plurality of implementations or in any proper sub-combination. In addition, while the features can function in some combinations as described herein and even are claimed initially, one or more features from the claimed combination can be removed from the combination in some cases, and the claimed combination can point to the sub-combination or a variant of the sub-combination.

Similarly, although operations are depicted in a particular order in the accompanying drawings, this should not be understood as requiring these operations to be executed in a particular order or executed in sequence, or requiring all illustrative operations to be executed, to achieve the desired results. In some cases, multi-task and parallel processing may be advantageous. In addition, separation of various system modules and components in the implementations herein should not be understood as requiring such separation in all implementations, and it should be understood that the described program components and systems can usually be integrated together in a single software product or encapsulated into a plurality of software products.

Therefore, specific implementations of the subject matter are described. Other implementations fall within the scope of the appended claims. In some cases, the actions recorded in the claims can be performed in a different order and still achieve the desired results. In addition, the processing depicted in the accompanying drawings does not necessarily need a particular order or sequential order to achieve the desired results. In some implementations, multi-task and parallel processing may be advantageous.

The descriptions herein are merely example implementations of the present application, and are not intended to limit the present application. Any modification, equivalent replacement, improvement, etc. made within the spirit and principles of the present application shall be included in the protection scope of the present application.

What is claimed is:

1. A data storage method, the method comprising:
deploying a database at a server, the database including a plurality of first data tables stored in a persistent storage space of the server and a second data table stored in a cache space of the server, the second data table configured to store incremental data to be written to a first data table;
in response to that metadata corresponding to a data table in the database changes, setting the second data table to be in an unmodifiable state, and writing the incremental data in the second data table to the first data table in the persistent storage space; and
creating a new second data table corresponding to the metadata that changes, and recording newly obtained incremental data in the second data table.

2. The method according to claim 1, wherein the deploying the database includes deploying a metadata manager, the metadata manager configured to maintain metadata corresponding to a data table in the database and an identifier of the metadata, wherein the first data table stores an identifier of first metadata corresponding to the first data table, and the second data table stores an identifier of second metadata corresponding to the second data table.

3. The method according to claim 2, wherein the metadata manager maintains the metadata in a form of a key-value pair, a key in the key-value pair is the identifier of the metadata, and a value in the key-value pair is the metadata.

4. The method according to claim 1, wherein the database includes an LSM-tree storage engine.

5. The method according to claim 2, further comprising:
determining that the metadata corresponding to the data table in the database changes in response to at least one of:
the metadata that corresponds to data table in the database and that is maintained by the metadata manager changes; or
metadata corresponding to the incremental data that is newly obtained is different from the metadata corresponding to the second data table.

6. The method according to claim 2, further comprising:
in response to that a data query request is obtained, querying a target data entry from the plurality of first data tables, and querying metadata corresponding to the target data entry from the metadata manager based on an identifier of metadata corresponding to a first data table in which the target data entry is located.

7. The method according to claim 2, further comprising:
combining the plurality of first data tables into a target first data table in response to a data table combination request for the plurality of first data tables.

8. The method according to claim 7, wherein the combining the plurality of first data tables into the target first data table includes:
obtaining latest metadata from the metadata manager based on an identifier of metadata stored in each of the plurality of first data tables; and
storing each data entry of the plurality of first data tables at a corresponding location in the target first data table based on the latest metadata.

9. An electronic device, comprising one or more storage devices, one or more processors, and a computer program that is stored, individually or collectively, in the one or more storage devices and that is capable of running on the one or more processors, wherein when the one or more processors executes the program, the one or more processors are enabled to, individually or collectively, implement a database at a server, the database including a plurality of first data tables stored in a persistent storage space of the server and a second data table stored in a cache space of the server, the second data table configured to store incremental data to be written to a first data table, and to implement actions including;
in response to that metadata corresponding to a data table in the database changes, setting the second data table to be in an unmodifiable state, and writing the incremental data in the second data table to the first data table in the persistent storage space; and
creating a new second data table corresponding to the metadata that changes, and recording newly obtained incremental data in the second data table.

10. The electronic device according to claim 9, wherein the database includes a metadata manager, the metadata manager configured to maintain metadata corresponding to a data table in the database and an identifier of the metadata, wherein the first data table stores an identifier of first metadata corresponding to the first data table, and the second data table stores an identifier of second metadata corresponding to the second data table.

11. The electronic device according to claim 10, wherein the metadata manager maintains the metadata in a form of a key-value pair, a key in the key-value pair is the identifier of the metadata, and a value in the key-value pair is the metadata.

12. The electronic device according to claim 9, wherein the database includes an LSM-tree storage engine.

13. The electronic device according to claim 10, wherein the actions include:
determining that the metadata corresponding to the data table in the database changes in response to at least one of:
the metadata that corresponds to data table in the database and that is maintained by the metadata manager changes; or
metadata corresponding to the incremental data that is newly obtained is different from the metadata corresponding to the second data table.

14. The electronic device according to claim 10, wherein the actions include:
in response to that a data query request is obtained, querying a target data entry from the plurality of first data tables, and querying metadata corresponding to the target data entry from the metadata manager based on an identifier of metadata corresponding to a first data table in which the target data entry is located.

15. The electronic device according to claim 10, wherein the actions include:
combining the plurality of first data tables into a target first data table in response to a data table combination request for the plurality of first data tables.

16. The electronic device according to claim 15, wherein the combining the plurality of first data tables into the target first data table includes:
obtaining latest metadata from the metadata manager based on an identifier of metadata stored in each of the plurality of first data tables; and
storing each data entry of the plurality of first data tables at a corresponding location in the target first data table based on the latest metadata.

17. A computer-readable storage medium having a computer program stored thereon, the computer program when executed by one or more processors, enabling the one or more processors to, individually or collectively, implement acts comprising:
deploying a database, the database including a plurality of first data tables stored in a persistent storage space and a second data table stored in a cache space, the second data table configured to store incremental data to be written to a first data table;
in response to that metadata corresponding to a data table in the database changes, setting the second data table to be in an unmodifiable state, and writing the incremental data in the second data table to the first data table in the persistent storage space; and
creating a new second data table corresponding to the metadata that changes, and recording newly obtained incremental data in the second data table.

18. The computer-readable storage medium according to claim 17, wherein the database includes a metadata manager, the metadata manager configured to maintain metadata corresponding to a data table in the database and an identifier of the metadata, wherein the first data table stores an identifier of first metadata corresponding to the first data table, and the second data table stores an identifier of second metadata corresponding to the second data table.

19. The computer-readable storage medium according to claim 18, wherein the metadata manager maintains the metadata in a form of a key-value pair, a key in the key-value pair is the identifier of the metadata, and a value in the key-value pair is the metadata.

20. The computer-readable storage medium according to claim 17, wherein the database includes an LSM-tree storage engine.
